(19) United States
(12) Patent Application Publication
(10) Pub. No.: US 2018/0223033 A1
(43) Pub. Date: Aug. 9, 2018

(54) CROSSLINKABLE COMPOSITION AND CURED PRODUCT USING THEREOF

(71) Applicant: University of Yamanashi, Kofu-shi (JP)

(72) Inventors: Hisatoyo Morinaga, Kofu-shi (JP); Mayu Sakamoto, Kofu-shi (JP)

(73) Assignee: University of Yamanashi, Kofu-shi (JP)

(21) Appl. No.: 15/885,593

(22) Filed: Jan. 31, 2018

(30) Foreign Application Priority Data
Feb. 7, 2017 (JP) JP2017-020209
Aug. 30, 2017 (JP) JP2017-166154

(51) Int. Cl. C08G 59/32; C08G 59/30; C08G 59/50

(52) U.S. Cl. CPC C08G 59/3263; C08G 59/502; C08G 59/302

(57) ABSTRACT

An object of the present invention is to provide a crosslinkable composition as a new crosslinking precursor, comprising a multifunctional epoxy compound using a plant component as a raw material, and a cured product obtained by curing the crosslinkable composition. The present invention provides a crosslinkable composition comprising: a plant-based multifunctional epoxy compound; and a crosslinking agent, wherein the multifunctional epoxy compound is obtained by multifunctionalizing limonene oxide, and the crosslinking agent is a polyalkyleneimine.

### TECHNICAL FIELD

The present invention relates to a crosslinkable composition comprising a multifunctional epoxy compound using a plant component as a raw material, and a cured product obtained by curing the crosslinkable composition.

### BACKGROUND

Multifunctional epoxy compounds are highly useful as epoxy resins for sealing agents such as adhesives and sealing agents for semiconductors and the like, paints and coating agents. In addition, limonene, one of terpene-based compounds, is a plant component extracted from citrus fruits such as oranges and grapefruits. Limonene is also attracting attention as a petroleum substitute raw material for chemical industrial products, since it is a renewable resource.

As a literature relating to the synthesis of a crosslinkable composition using limonene for sealing agents, paints and coating agents, for example, Non-Patent Literature 1 which discloses the synthesis of a crosslinked product by crosslinking of limonene and a multifunctional thiol has been known. Non-Patent Literature 1 discloses that a crosslinking precursor is formed by an ene-thiol reaction between the limonene and a multifunctional thiol, another multifunctional thiol is further added thereto, and then heating or light irradiation is performed to produce a crosslinked product. Patent Literature 1 discloses that a monomer for a crosslinked polymer is provided by introducing a plurality of polymerizable (meth) acrylate groups into the limonene.

### CITATION LIST

### Non-Patent Literature

[Non-Patent Literature 1] Polymer Chemistry, 2014, vol. 5, p 3245-3260.

### PATENT LITERATURE

[Patent Literature 1] JP5294259B2

### SUMMARY OF INVENTION

### Technical Problem

Conventionally, a crosslinkable composition comprising a multifunctional epoxy compound and a cured product obtained by curing the crosslinkable composition has been known. In addition, a development using renewable resources derived from a plant component as a substitute material for petroleum in recent chemical industry products has been carried out. However, a satisfactory crosslinkable composition derived from the plant component has not been obtained.

The present invention has been made by taking the afore-mentioned circumstances into consideration. The present invention provides a crosslinkable composition as a new crosslinking precursor, comprising a multifunctional epoxy compound using a plant component as a raw material, and a cured product obtained by curing the crosslinkable composition.

### Solution to Problem

The present invention provides a crosslinkable composition comprising: a plant-based multifunctional epoxy compound; and a crosslinking agent, wherein the multifunctional epoxy compound was obtained by multifunctionalizing limonene oxide, and the crosslinking agent is a polyalkyleneimine.

The present inventors found that a crosslinkable composition using a plant component as a raw material can be obtained by comprising a plant-based multifunctional epoxy compound which is obtained by multifunctionalizing limonene oxide and a polyalkyleneimine as a crosslinking agent, and then completed the present invention.

Hereinafter, embodiments of the present invention will be exemplified. The following embodiments can be combined with each other.

Preferably, the crosslinking agent is a polyethyleneimine.

Preferably, the crosslinking agent is a polyethyleneimine having a branched structure.

Preferably, the plant-based multifunctional epoxy compound is a compound obtained by reacting the limonene oxide and a multifunctional thiol.

Preferably, the limonene oxide contains limonene oxide in a trans form of 40 mol % or more with respect to all limonene oxide.

Preferably, the plant-based multifunctional epoxy compound is a tetrafunctional epoxy compound.

Preferably, a cured product obtained by curing the crosslinkable composition. Preferably, an adhesive comprising the crosslinkable composition.

### BRIEF DESCRIPTION OF DRAWINGS

FIG. 1A shows an example of a cured product obtained from the crosslinkable composition (Example 12).

FIG. 1B shows an example of two slide glasses bonded by a cured product obtained from the crosslinkable composition (Example 12).

FIG. 2 shows an example of a synthesis scheme of the plant-based multifunctional epoxy compound.

FIG. 3 shows an example of a preparation scheme of the crosslinkable composition and a synthetic scheme of the crosslinked product thereof.

FIG. 4 shows an example of a synthetic scheme of a crosslinked product according to a reference example.

FIG. 5 shows an example of a thermogravimetric measurement result (comparison with Example 21 and Reference Example).

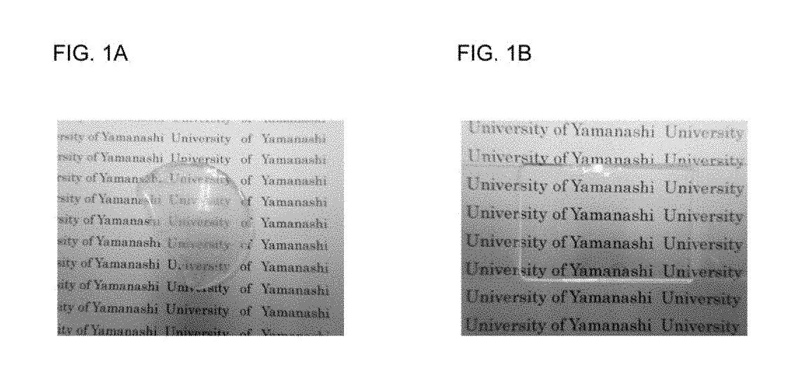

### DESCRIPTION OF EMBODIMENTS

Hereinafter, preferred embodiments of the present invention will be specifically described.

The crosslinkable composition of the present invention is characterized by comprising a plant-based multifunctional epoxy compound; and a crosslinking agent, wherein the multifunctional epoxy compound is obtained by multifunctionalizing limonene oxide, and the crosslinking agent is a polyalkyleneimine. Each component will be described in detail below.

1-1. Plant-Based Multifunctional Epoxy Compound

The plant-based multifunctional epoxy compound is obtained by multifunctionalizing limonene oxide (an oxidized derivative of limonene which is a plant component) represented by the following formula (1) and has crosslinking property.

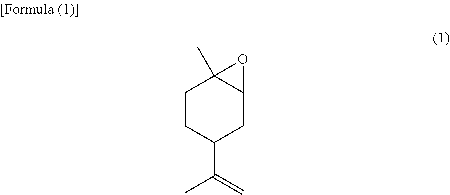

Limonene oxide can be obtained as oxidized derivative of limonene which is a plant component come from citrus. Further, commercially available products such as (R)-limonene oxide manufactured by Wako Pure Chemical Industries, Ltd. may also be used.

Examples of limonene oxide include isomeric mixtures of cis and trans isomers. Regarding the reactivity of limonene oxide, it is believed that the structure of the trans form is more likely to react with a nucleophilic reagent such as amine. Depending on the structure of the limonene oxide used, the reactivity may relate to the physical properties of the crosslinkable composition described below. The content of the cis- and trans-forms of limonene oxide contained in the crosslinkable composition is not limited, but it is preferable that the limonene oxide contains limonene oxide in a trans form of 40 mol % or more with respect to all limonene oxide. Since the trans-form of limonene oxide tends to react with a nucleophilic reagent such as an amine, it is considered that a crosslinking reaction with polyalkyleneimine may be easily formed and the formed product may have higher heat resistance as a crosslinked. That is, in order to obtain a cured product having higher heat resistance in the cured product obtained from the crosslinkable composition, the limonene oxide more preferably contains limonene oxide in a trans form of 40 mol % or more with respect to all limonene oxide. When the limonene oxide contains limonene oxide in a trans form of 45 mol % or more with respect to all limonene oxide, the content of the trans form with respect to all limonene oxide can be in the range of two values selected from the group consisting of 45 mol %, 50 mol %, 55 mol %, 60 mol %, 65 mol %, 70 mol %, 75 mol %, 80 mol %, 85 mol %, 90 mol %, 95 mol %, 100 mol %.

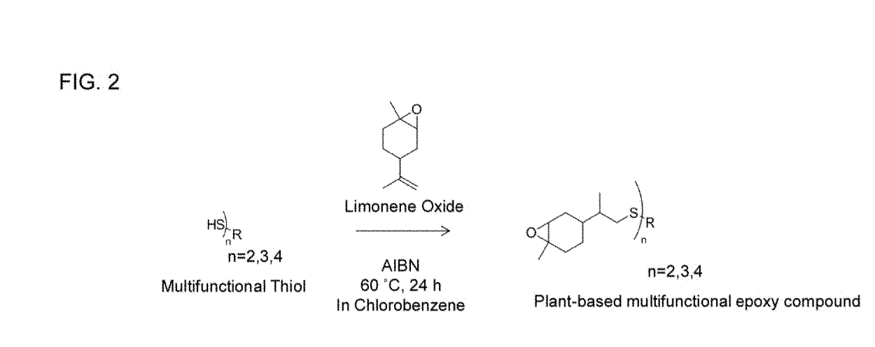

A plant-based multifunctional epoxy compound can be obtained by multifunctionalizing the limonene oxide as a raw material. An example method for multifunctionalizing the limonene oxide, though it is not limited, preferably comprises Thiol-ene Reaction by reacting limonene oxide and multifunctional thiol in the presence of azobisisobutyronitrile (AIBN) as a radical generator, since the plant-based multifunctional epoxy compound can be easily obtained. An example of a scheme for synthesizing the plant-based multifunctional epoxy compound is as shown in FIG. 2.

The multifunctional thiol is not particularly limited and may be a compound having two or more thiol groups in the molecule. Examples of multifunctional thiol include 1,2-ethanedithiol, 1,3-propanedithiol, 1,4-butanedithiol, 2,3-butanedithiol, 1,5-pentanedithiol, 1,6-hexanedithiol, 2,5-hexanedithiol, 1,8-octanedithiol, 1,9-nonanedithiol, 2,9-decanedithiol, 2,3-dimercapto-1-propanol, dithioerythritol, 1,2-benzenedithiol, 1, 2-benzene dimethanedithiol, 3,4-dimercaptotoluene, 4-chloro-1,3-benzenedithiol, ethylene glycol bis (3-mercaptopropionate), trimethylolpropane tris (3-mercaptopropionate), trismethylolpropane tris thioglycolate, pentaerythritol tetrakisthioglycolate, pentaerythritol tetrakis (3-mercaptopropionate), pentaerythritol tetrakisthiopropionate, ethylene glycol bisthiopropionate, trimethylolpropane tris thiopropionate, (2-mercaptopropyl ester) phthalate, bis (2-mercaptobutyl ester) phthalate, ethylene glycol bis (3-mercaptobutyrate), diethylene glycol bis (3-mercaptobutyrate), propylene glycol bis (3-mercapto butyrate), 1,3-butanediol bis (3-mercaptobutyrate), trimethylolpropane tris (3-mercaptobutyrate), pentaerythritol tetrakis (3-mercaptobutyrate), propylene glycol bis (2-mercaptoisobutyrate), pentaerythritol tetrakis (2-mercaptoisobutyrate), trimethylolpropane tris (3-mercaptoisobutyrate). These multifunctional thiols may be used singly or in combination of plural kinds. The number-average molecular weight of the multifunctional thiol is preferably 100 to 10,000, more preferably 100 to 5,000, more preferably 100 to 2,000, more preferably 100 to 1,000, and even more preferably from 100 to 500.

For example, bifunctional to tetrafunctional thiol represented by the following formulas (2) to (4) are preferably used as the multifunctional thiol.

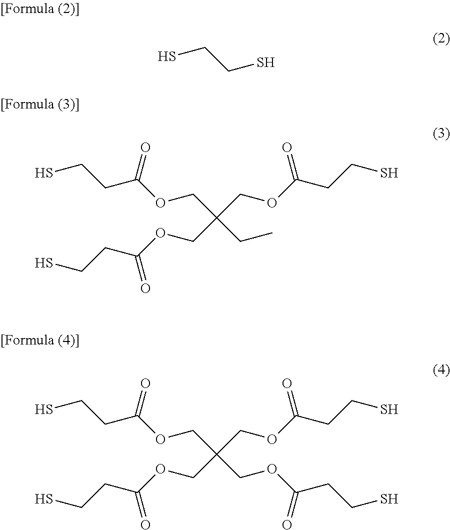

In the case of synthesizing a plant-based multifunctional epoxy compound with limonene oxide and a multifunctional thiol, by using the compounds of the above formulas (2) to (4) as multifunctional thiols, the bifunctional to tetrafunctional plant-based multifunctional epoxy compound represented by the following formulas (5) to (7). The plant-based multifunctional epoxy compound does not need multi-step reactions for a synthesis and is simpler, for example, than synthesis of an epoxy compound as described in Patent Literature 1. Moreover, the plant-based multifunctional epoxy compound is preferable because the plant-based multifunctional epoxy compound does not have a highly reactive functional group (for example, an acrylate group or a methacrylate group) and therefore has high stability during storage.

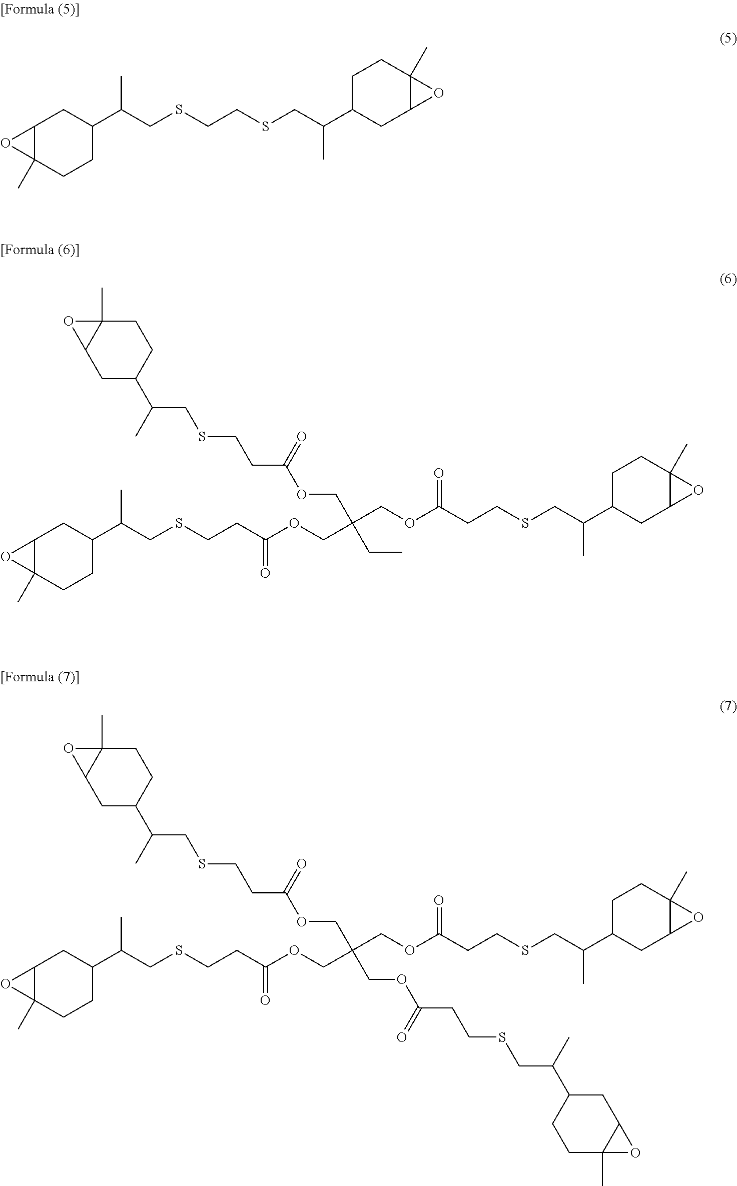 [SMILES: CC(CSCCSCC(C)C1CCC2(C)OC2C1)C1CCC2(C)OC2C1 ; CCC(COC(=O)CCSCC(C)C1CCC2(C)OC2C1)(COC(=O)CCSCC(C)C1CCC2(C)OC2C1)COC(=O)CCSCC(C)C1CCC2(C)OC2C1 ; CC(CSCCC(=O)OCC(COC(=O)CCSCC(C)C1CCC2(C)OC2C1)(COC(=O)CCSCC(C)C1CCC2(C)OC2C1)COC(=O)CCSCC(C)C1CCC2(C)OC2C1)C1CCC2(C)OC2C1]

In synthesizing the plant-based multifunctional epoxy compound, the content of the multifunctional thiol with respect to the limonene oxide is not particularly limited, but the composition comprises preferably 0.05 to 2.0 equivalents, more preferably 0.2 to 1.5 equivalents of the thiol group number with respect to the number of carbon-carbon double bond groups in the limonene oxide.

In synthesizing the plant-based multifunctional epoxy compound, a radical generator may be contained in addition to limonene oxide and multifunctional thiol. The radical generator is one which generates radicals by heat, light or the like. Examples of the radical generator include azo compounds and organic peroxides, which may be used in combination. The content of the radical generator is not particularly limited, but the content is preferably in the range of 0.1 to 10 parts by mass with respect to 100 parts by mass of the composition containing limonene oxide and multifunctional thiol.

Examples of the azo compound include 2,2′-azobispropane, 2,2′-dichloro-2,2′-azobispropane, 1,1′-azo (methylethyl) diacetate, 2,2′-azobisisobutane, 2,2′-azobisisobutyramide, 2,2′-azobisisobutyronitrile (AIBN), methyl 2,2′-azobis-2-methylpropionate, 2,2′-dichloro-2,2′-azobisbutane, 2,2′-azobis-2-methylbutyronitrile, dimethyl 2,2′-azobisisobutyrate, 3,5-dihydroxymethylphenylazo-2-methylmalonodinitrile, 2,2′-azobis-2-methylvaleronitrile, dimethyl 4,4′-azobis-4-cyanovalerate, 2,2′-azobis-2,4-dimethylvaleronitrile and the like.

Examples of the organic peroxide include benzoyl peroxide, cumene hydroperoxide, di-tert-butyl peroxide, tert-butyl hydroperoxide, dicumyl peroxide and the like.

The plant-based multifunctional epoxy compound can provide a crosslinkable composition containing polyalkyleneimine described below, and the cured product obtained by curing the composition has the same degree of performance in heat resistance, adhesiveness and light transmittance even when compared with cured products prepared using conventionally known epoxy compounds. That is, it is possible to obtain using the plant component as a raw material, a crosslinkable composition having the same performance as the cured product obtained by curing the known crosslinkable composition.

1-2. Crosslinking Agent

The crosslinkable composition is characterized in that the plant-based multifunctional epoxy compound contains polyalkyleneimine as a crosslinking agent. Hereinafter, polyalkyleneimine will be described.

The polyalkyleneimine has reactivity for allowing the ring-opening addition reaction between the plant-based multifunctional epoxy compound and the crosslinking reaction. Therefore, the polyalkyleneimine can be used as a crosslinking agent. The polyalkyleneimine is, for example, a polymer prepared by normally polymerizing one or more alkyleneimine having 2 to 8 carbon atoms, preferably having 2 to 4 carbon atoms such as ethyleneimine, propylenimine, butyleneimine, dimethylethyleneimine, pentyleneimine, hexyleneimine, heptyleneimine, octyleneimine, alkyleneimine, or a derivative of a polymer chemically modified by reacting them with various compounds etc. These may be used in combination. The structure of the polyalkyleneimine is not particularly limited, and any of a linear polyalkyleneimine and a polyalkyleneimine having a branched structure can be used.

The polyalkyleneimine can have various molecular weights, but its weight-average molecular weight is in the range of 300 to 100,000. The weight-average molecular weight is preferably in the range of 300 to 70,000, more preferably 500 to 30,000, further preferably 600 to 10,000.

Regarding the branched structure of the polyalkyleneimine, it can be expressed by the abundance ratio of the primary amino group, the secondary amino group and the tertiary amino group present in the molecular skeleton, that is the degree of branching. The branched structure is not particularly limited, but it is preferred that the primary amino group, the secondary amino group and the tertiary amino group are contained 25 to 45 mol %, 35 to 50 mol %, 20 to 35 mol % with respect to the all amino groups, respectively. It is more preferred that the primary amino group, the secondary amino group and the tertiary amino group are contained 30 to 40 mol %, 30 to 40 mol %, 25 to 35 mol % with respect to the all amino groups, respectively.

Among polyalkyleneimines, it is particularly preferable to use polyethyleneimine. Further, it is more preferable to use polyethyleneimine having a branched structure. The polyethyleneimine having a branched structure (hereinafter referred to as BPEI) is, for example, preferably BPEI containing primary, secondary, and tertiary amines represented by the following formula (8). Such BPEI can be synthesized, for example, by ring-opening polymerization of ethylene imine in the presence of an acid catalyst. Of course, commercially available BPEI such as Epomin (registered trademark) (SP-003, SP-006, SP-012, SP-018, SP-200 and P-1000) available from Nippon Shokubai Co., Ltd., 161-17831 (average molecular weight about 600), 167-17811 (average molecular weight about 1,800), and 164-17821 (average molecular weight 10,000) available from Wako Pure Chemical Industries, Ltd., or the like may be used.

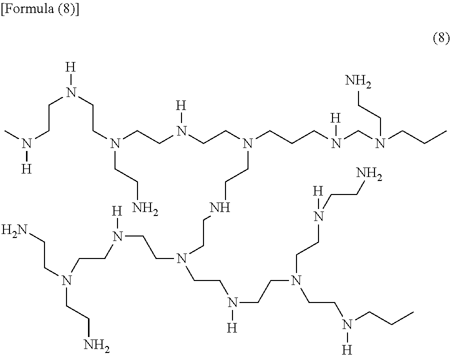 [SMILES: CCCNCCN(CCNCCN)CCNCCN(CCNCCN(CCN)CCN)CCNCCN(CCCNCN(CCC)CCN)CCNCCN(CCN)CCNCCNC]

1-3. Crosslinkable Composition

The crosslinkable composition is characterized by including the plant-based multifunctional epoxy compound and the polyalkyleneimine as the crosslinking agent. In the crosslinkable composition of the present invention, the kind of the plant-based multifunctional epoxy compound, the molecular weight of the polyalkyleneimine, or the mixing ratio thereof is not particularly limited, and the hardness, heat resistance and yield of the cured product obtained from the crosslinkable composition can be arranged by combining various kinds thereof.

In the crosslinkable composition, the plant-based multifunctional epoxy compound has preferably 2 to 6 functional groups, more preferably 2 to 4 functional groups, and further preferably 3 to 4 functional groups. The plant-based multifunctional epoxy compound is most preferably a tetrafunctional epoxy compound in view of that the yield at the time of crosslinking the crosslinkable composition can be increased and the heat resistance of the obtained cured product can be improved. In addition, as another aspect, the crosslinkable composition has a higher adhesive force when the plant-based multifunctional epoxy compound has 3 to 4 functional groups compared to the case where the plant-based multifunctional epoxy compound has 2 or less functional groups. The plant-based multifunctional epoxy compound has particularly high adhesive strength when the plant-based multifunctional epoxy compound has 3 to 4 functional groups. With respect to the content of the plant-based multifunctional epoxy compound and the polyalkyleneimine, when the plant-based multifunctional epoxy compound has 2 functional groups, the crosslinkable composition comprises preferably 15 to 45 mass %, more preferably 20 to 45 mass %, more preferably 25 to 45 mass %, and even more preferably 28 to 43 mass % of the polyalkyleneimine. With respect to the content of the plant-based multifunctional epoxy compound and the polyalkyleneimine, when the plant-based multifunctional epoxy compound has 3 functional groups, the crosslinkable composition comprises preferably 10 to 40 mass %, more preferably 15 to 40 mass %, more preferably 20 to 40 mass %, and even more preferably 21 to 35 mass % of the polyalkyleneimine. With respect to the content of the plant-based multifunctional epoxy compound and the polyalkyleneimine, when the plant-based multifunctional epoxy compound has 4 functional groups, the crosslinkable composition comprises preferably 10 to 40 mass %, more preferably 15 to 40 mass %, more preferably 20 to 40 mass %, and even more preferably 22 to 36 mass % of the polyalkyleneimine. As mentioned above, by modifying the content of the plant-based multifunctional epoxy compound and the polyalkyleneimine, by modifying the number of functional groups of the plant-based multifunctional epoxy compound, or by changing the molecular weight and structure of the polyalkyleneimine, it is possible to obtain the product having the properties from relatively hard cured product to flexible elastomer. Moreover, by adjusting the number of functional groups of the plant-based multifunctional epoxy compound, the adhesive strength can be adjusted and the crosslinkable composition can be used in practical situations where high adhesive strength is required.

The crosslinkable composition preferably comprises a plant-based multifunctional epoxy compound using the above-mentioned limonene oxide as a raw material and BPEI as a crosslinking agent. It is known that the epoxy moiety of limonene oxide which undergoes ring-opening addition reaction is difficult to react due to the epoxy moiety's steric hindrance, but in the combination with BPEI, the ring-opening addition reaction proceeds smoothly. In addition, in the case of this combination, the crosslinking reaction can be inhibited as long as the crosslinkable composition is not heated, and the crosslinkable composition can be stably stored.

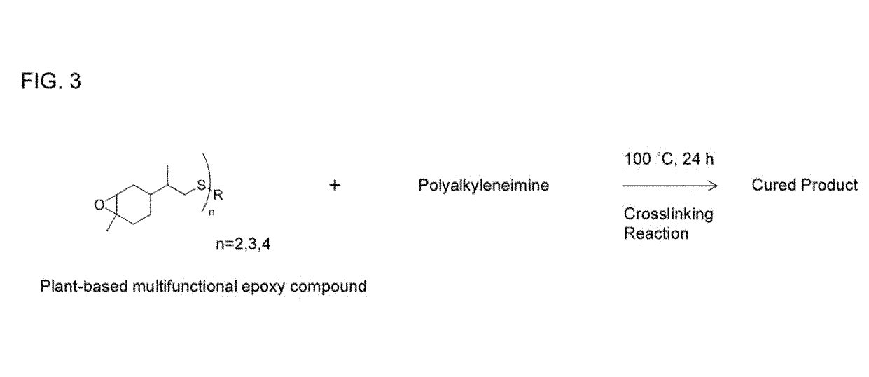

The method for producing the crosslinkable composition is not particularly limited, but the crosslinkable composition can be easily obtained by homogeneously mixing by a conventional method at least the plant-based multifunctional epoxy compound and the polyalkyleneimine. When mixing, dilution with a solvent or the like is not particularly required, but it can be prepared by using a general solvent for adjusting the viscosity of the crosslinkable composition to be obtained. An example of a preparation scheme of the crosslinkable composition and a synthetic scheme of the crosslinked product is shown in FIG. 3.

The crosslinkable composition comprises at least a plant-based multifunctional epoxy compound and a polyalkyleneimine as a crosslinking agent, but if necessary, the crosslinkable composition may comprise a polymerization inhibitor, a photopolymerization initiator, a thermal polymerization initiator, an antioxidant, a light stabilizer, an ultraviolet absorber, an adhesion agent, a release agent, a pigment, a dye, and the like.

A cured product of the crosslinkable composition can be obtained by a crosslinking reaction of the plant-based multifunctional epoxy compound and polyalkyleneimine. The method of the crosslinking reaction is not particularly limited, but as a simple method, the crosslinking reaction can be performed by heating the crosslinkable composition in air, and then the cured product can be obtained easily. The cured product can be industrially applied to adhesives, sealing agents, paints, coating agents, molded bodies and the like based on the properties thereof. Moreover, the plant-based multifunctional epoxy compound can be stably stored unless it is mixed with polyalkyleneimine and heated. Even if both are mixed, for example, the mixture can be stored without proceeding the crosslinking reaction for several weeks when the mixture is refrigerated at 10° C. or less.

The cured product can be applied to a base material on which it is capable of forming the cured product of the present invention irrespective of the above application. For example, in the case of using as an adhesive, the base material to be bonded is not particularly limited, but in general, various materials such as plastic, glass, metal, wood, paper and the like can be used. A method for adhering is not particularly limited, but an adhesive having a crosslinkable composition is applied, for example, to an arbitrary base material selected from the above base materials as an object to be bonded, and the adhesive on the base is brought into contact with another base material and cured.

In preparing the cured product, various methods can be adopted according to application. For example, in the case of forming a cured product for protecting the surface of a coating or the like, a crosslinkable composition is applied to a substrate at a desired thickness, and then cured the composition by heating to form a cured film. If an organic solvent is contained, the solvent is volatilized before the heating. When the molded body is formed from the cured product of the present invention, for example, after the crosslinkable composition is injected or applied to a mold having a desired shape, the crosslinkable composition is cured by heating, and the molded body is released from the mold or the like.

### EXAMPLE

Examples and Comparative Examples of the present invention are shown below, but the present invention is not intended to be limited thereto.

<Synthesis of Plant-Based Multifunctional Epoxy Compound>

First, the plant-based multifunctional epoxy compound was prepared using limonene oxide as a raw material as follows.

### Synthesis Example 1

Commercially available limonene oxide (Wako Pure Chemical Industries, Ltd. (R)-Limonene oxide (isomer mixture)) and 2 equivalents of the bifunctional thiol of the above formula (2) were added into chlorobenzene in the presence of AIBN, and reacted for 24 hours. The obtained solution after the reaction was purified with a chromatography or dried by heating under reduced pressure to obtain a plant-based bifunctional epoxy compound (the above formula (5)). Structural analysis of the resulting plant-based bifunctional epoxy compound was performed by nuclear magnetic resonance spectroscopy (NMR).

### Synthesis Example 2

Using the trifunctional thiol of the above formula (3) and 3 equivalents of limonene oxide, the reaction was carried out in the same manner as in Synthesis Example 1 to obtain a plant-based trifunctional epoxy compound (the above formula (6)) after the reaction. Structural analysis of the resulting plant-based trifunctional epoxy compound was performed by nuclear magnetic resonance spectroscopy (NMR).

### Synthesis Example 3

Using the tetrafunctional thiol of the above formula (4) and 4 equivalents of limonene oxide, the reaction was carried out in the same manner as in Synthesis Example 1 to obtain a plant-based trifunctional epoxy compound (the above formula (7)) after the reaction. Structural analysis of the resulting plant-based tetrafunctional epoxy compound was performed by nuclear magnetic resonance spectroscopy (NMR).

### EXAMPLES, COMPARATIVE EXAMPLES, REFERENCE EXAMPLES

Using the plant-based multifunctional epoxy compound obtained in Synthesis Examples 1 to 3, a commercially available epoxy compound and various crosslinking agents, a cured product of the crosslinkable composition was prepared as follows.

### Example 1

80% by mass of the plant-based bifunctional epoxy compound obtained in Synthesis Example 1 and 20% by mass of BPEI (BPEI (600)) having a molecular weight of 600 as polyalkyleneimine were mixed and heated in air at 100° C. for 24 hours, and a crosslinking reaction was carried out. A cured product of Example 1 was obtained.

### Examples 2 to 9

Plant-based bifunctional epoxy compound obtained in Synthesis Example 1 and BPEI having respective molecular weights were mixed at the ratio (mass %) shown in Table 1 and the cured products of Examples 2 to 9 were prepared in the same manner as in Example 1.

### Examples 10 to 18

Plant-based trifunctional epoxy compound obtained in Synthesis Example 2 and BPEI having respective molecular weights were mixed at the ratio (mass %) shown in Table 2 and the cured products of Examples 10 to 18 were prepared in the same manner as in Example 1. Moreover, when the crosslinkable composition of Example 12 was applied between two glass slides and crosslinked at 100° C., these were firmly adhered. The transmittance of the adhesive was 91.2%.

### Examples 19 to 27

Plant-based tetrafunctional epoxy compound obtained in Synthesis Example 3 and BPEI having respective molecular weights were mixed at the ratio (mass %) shown in Table 3 and the cured products of Examples 19 to 27 were prepared in the same manner as in Example 1. Moreover, when the crosslinkable composition of Example 21 was applied between two glass slides and crosslinked at 100° C., these were firmly adhered. The transmittance of the adhesive was 91.2%.

### Comparative Example 1

95% by mass of the plant-based bifunctional epoxy compound obtained in Synthesis Example 1 and 5% by mass of tetraethylenepentamine as a crosslinking agent were mixed and operation was performed in the same manner as in Example 1. However, the crosslinking reaction did not proceed and a cured product could not be obtained.

### Comparative Example 2

The same procedure as in Comparative Example 1 was carried out except that 97% by mass of the plant-based bifunctional epoxy compound and 3% by mass of 2-ethyl-4-methylimidazole as a crosslinking agent instead of tetraethylenepentamine were mixed. The procedure was carried out, but the crosslinking reaction did not proceed and a cured product could not be obtained.

### Comparative Example 3

The same procedure as in Comparative Example 2 was carried out except that 98% by mass of the plant-based tetrafunctional epoxy compound and 2% by mass of 2-ethyl-4-methylimidazole as a crosslinking agent instead of tetraethylenepentamine were mixed. The procedure was carried out, but the crosslinking reaction did not proceed and a cured product could not be obtained.

### Reference Example

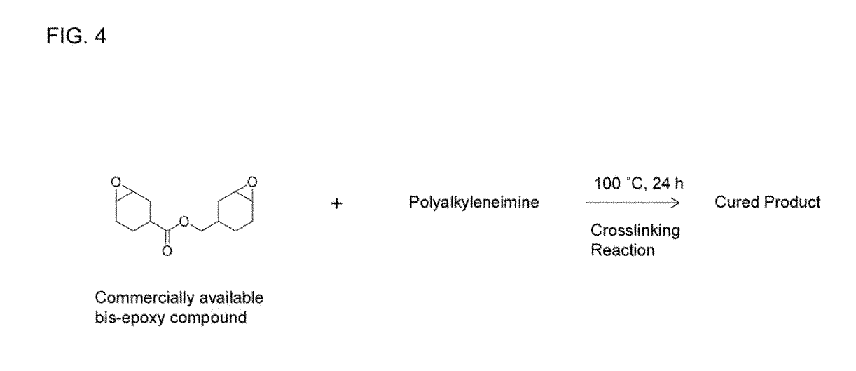

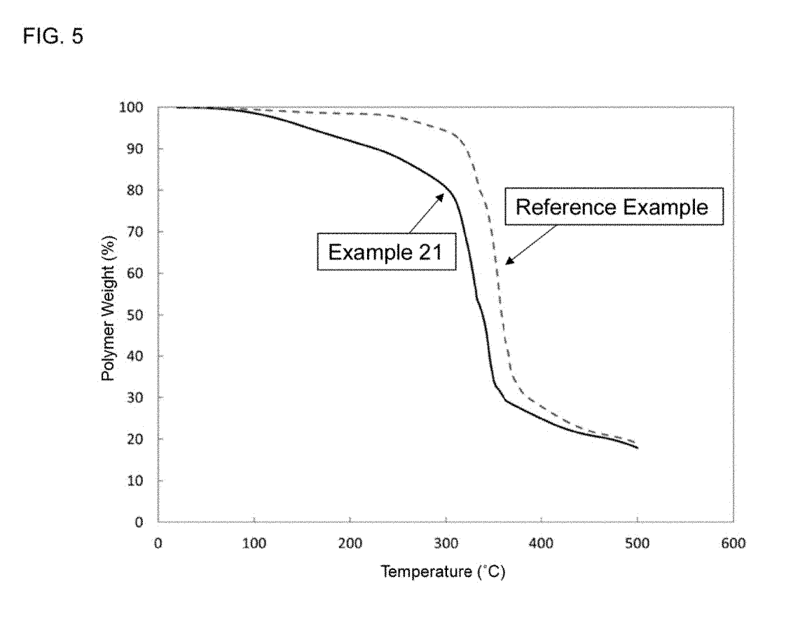

As a reference, a cured product of Reference Example was prepared by using a commercially available alicyclic bisepoxy compound represented by the following formula (9) instead of a plant-based multifunctional epoxy compound. A composition was prepared by mixing 55% by mass of alicyclic bis-epoxy compound with 45% by mass of BPEI having a molecular weight of 10,000, and operating according to the same procedure as in Example 1 to obtain a cured product. The scheme is as shown in FIG. 4. Also, when the composition prepared above was applied between two slide glasses and crosslinked at 100° C., these were firmly adhered, and the transmittance of the adhesive was 90.7%.

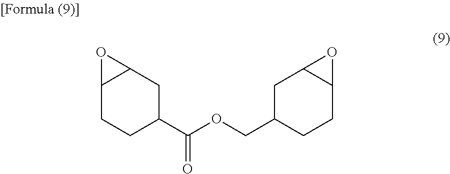 [SMILES: O=C(OCC1CCC2OC2C1)C1CCC2OC2C1]

<Measurement of Yield of Cured Product>

The obtained cured product was subjected to Soxhlet extraction treatment using acetone as a solvent for about 12 hours to calculate the yield.

<Measurement of Yield of Cured Product by Thermogravimetry and Differential Thermal Analysis>

The relation between the thermal weight reduction rate and the temperature of the cured product obtained using Rigaku TG-DTA was measured. The measurement was carried out at an elevated temperature rate of 10° C. per minute under an air atmosphere. Based on the obtained results, the 10% thermal weight loss temperature was calculated.

<Measurement of Transmittance>

A crosslinkable composition was applied to two slide glasses and cured by heating at 100° C., and transmittance was measured with UV-Vis spectrophotometer manufactured by Shimadzu.

Conditions and measurement results of Examples, Comparative Examples, Reference Examples are shown in Tables 1 to 4.

TABLE 1

| | | Example | | | | | | | | |
|---|---|---|---|---|---|---|---|---|---|---|
| | | 1 | 2 | 3 | 4 | 5 | 6 | 7 | 8 | 9 |
| Epoxy compound | Plant-based Bifunctional Epoxy compound | 80 | 72 | 57 | 80 | 72 | 57 | 80 | 72 | 57 |
| [mass %] | Plant-based Trifunctional Epoxy compound | | | | | | | | | |
| | Plant-based Tetrafunctional Epoxy compound | | | | | | | | | |
| | Alicyclic bis Epoxy compound | | | | | | | | | |
| Crosslinking | BPEI (600) | 20 | 28 | 43 | | | | | | |
| agent | BPEI (1800) | | | | 20 | 28 | 43 | | | |
| [mass %] | BPEI (10000) | | | | | | | 20 | 28 | 43 |
| | Tetraethylene pentamine | | | | | | | | | |
| | 2-ethyl-4-methylimidazole | | | | | | | | | |

| | | | | | | | | | |
|---|---|---|---|---|---|---|---|---|---|
| Yield [%] | 0.2 | 1 | 3 | 14 | 16 | 74 | 33 | 46 | 62 |
| 10% thermal weight loss temperature [° C.] | — | — | — | — | — | 220.3 | — | — | 140.7 |
| Transmittance [% @ 400 nm] | — | — | — | — | — | 90.9 | — | — | — |

TABLE 2

| | | Example | | | | | | | | |
|---|---|---|---|---|---|---|---|---|---|---|
| | | 10 | 11 | 12 | 13 | 14 | 15 | 16 | 17 | 18 |
| Epoxy compound | Plant-based bifunctional Epoxy compound | | | | | | | | | |
| [mass %] | Plant-based Trifunctional Epoxy compound | 85 | 79 | 65 | 85 | 79 | 65 | 85 | 79 | 66 |
| | Plant-based Tetrafunctional Epoxy compound | | | | | | | | | |
| | Alicyclic bis Epoxy compound | | | | | | | | | |
| Crosslinking | BPEI (600) | 15 | 21 | 35 | | | | | | |
| agent | BPEI (1800) | | | | 15 | 21 | 35 | | | |
| [mass %] | BPEI (10000) | | | | | | | 15 | 21 | 34 |
| | Tetraethylene pentamine | | | | | | | | | |
| | 2-ethyl-4-methylimidazole | | | | | | | | | |

| | | | | | | | | | |
|---|---|---|---|---|---|---|---|---|---|
| Yield [%] | 63 | 77 | 100 | 42 | 60 | 85 | 45 | 44 | 58 |
| 10% thermal weight loss temperature [° C.] | — | — | 202.2 | — | — | 243.2 | — | — | 164.0 |
| Transmittance [% @ 400 nm] | — | — | 91.2 | — | — | — | — | — | — |

TABLE 3

| | | Example | | | | | | | | |
|---|---|---|---|---|---|---|---|---|---|---|
| | | 19 | 20 | 21 | 22 | 23 | 24 | 25 | 26 | 27 |
| Epoxy compound | Plant-based bifunctional Epoxy compound | | | | | | | | | |
| [mass %] | Plant-based Trifunctional Epoxy compound | | | | | | | | | |
| | Plant-based Tetrafunctional Epoxy compound | 85 | 78 | 64 | 85 | 78 | 64 | 85 | 78 | 64 |
| | Alicyclic bis Epoxy compound | | | | | | | | | |
| Crosslinking | BPEI (600) | 15 | 22 | 36 | | | | | | |
| agent | BPEI (1800) | | | | 15 | 22 | 36 | | | |
| [mass %] | BPEI (10000) | | | | | | | 15 | 22 | 36 |
| | Tetraethylene pentamine | | | | | | | | | |
| | 2-ethyl-4-methylimidazole | | | | | | | | | |

| | | | | | | | | | |
|---|---|---|---|---|---|---|---|---|---|
| Yield [%] | 61 | 77 | 95 | 44 | 63 | 90 | 57 | 64 | 86 |
| 10% thermal weight loss temperature [° C.] | — | — | 226.8 | — | — | 200.6 | — | — | 227.7 |
| Transmittance [% @ 400 nm] | — | — | 91.1 | — | — | — | — | — | — |

TABLE 4

| | | Comparative Example | | | Reference |
|---|---|---|---|---|---|
| Table 4 | | 1 | 2 | 3 | Example |
| Epoxy compound | Plant-based bifunctional Epoxy compound | 95 | 97 | | |
| [mass %] | Plant-based Trifunctional Epoxy compound | | | | |
| | Plant-based Tetrafunctional Epoxy compound | | | 98 | |
| | Alicyclic bis Epoxy compound | | | | 55 |
| Crosslinking | BPEI (600) | | | | |
| agent | BPEI (1800) | | | | |
| [mass %] | BPEI (10000) | | | | 45 |
| | Tetraethylene pentamine | 5 | | | |
| | 2-ethyl-4-methylimidazole | | 3 | 2 | |

| | | | | |
|---|---|---|---|---|
| Yield [%] | 0 | 0 | 0 | 80 |
| 10% thermal weight loss temperature [° C.] | * | * | * | 321.1 |
| Transmittance [% @ 400 nm] | * | * | * | 90.7 |

* means “Unmeasurable”.

According to the results of Tables 1 to 3, it was possible to obtain a cured product from the plant-based multifunctional epoxy compound of the present invention and a crosslinkable composition containing polyalkyleneimine as a crosslinking agent. Moreover, by increasing the number of functional groups of the plant-based multifunctional epoxy compound, it was possible to obtain a cured product with higher yield. As can be seen from the measurement results of the cured products of Example 6, Example 12, and Example 21, the cured products obtained from any of the plant-based multifunctional epoxy compounds also had a 10% thermal weight reduction temperature of 200° C. or higher. Although this result is inferior to the 10% thermal weight loss temperature of the cured product obtained from the conventional epoxy compound shown as a reference example in Table 4, if the use environment is less than 100° C., the adhesive, the sealant, the paint, the coating agent and the like, which is sufficient for practical use. In addition, when the crosslinkable compositions of Examples 12 and 21 were applied between two slide glasses and crosslinked at 100° C., it was confirmed that they were firmly adhered and useful as an adhesive. In addition, it was confirmed that the transmittance of the slide glass laminated by these adherents was 90% or more and high transparencies. In Comparative Examples 1 to 3 using a crosslinking agent outside the scope of the present invention, it was impossible to obtain a cured product from the plant-based multifunctional epoxy compound of the present invention. Since the plant-based multifunctional epoxy compound of the present invention has a single structure and a single molecular weight as a crosslinking precursor, it has reproducibility of physical properties of the cured product after crosslinking. In addition, when the crosslinkable composition of the present invention is used as an adhesive, the adhesion strength is more stable than the prior art, and variations can be suppressed.

<Tensile Shear Bond Strength>

Example 6 (BPEI (1800)), Example 9 (BPEI (10000)) using a plant-based bifunctional epoxy compound, Example 12 (BPEI (600) using a plant-based trifunctional epoxy compound, Example 21 (BPEI (600)), Example 24 (BPEI (1800)) using Example 4 (BPEI (1800)), Example 18 (BPEI (10000)), plant-based tetrafunctional epoxy compound, Example 27 (BPEI (10000)), the results of evaluation of the adhesive strength are shown in Table 5. The bonding method and the adhesion strength were evaluated by a tensile shear bond strength test according to the method of Japanese Industrial Standard (JIS method: JIS K6850). A metal plate (stainless steel 304) was used as an adherend. A metal plate (stainless steel 304; 100 mm×25 mm×1.5 mm) was used as an adherend and was bonded in the air at 100° C. for 24 hours. The adhesive strength was measured with a universal testing machine RTC-1310 (manufactured by ORIENTEC). The pulling rate was 5 mm/min.

TABLE 5

| | Example | | | | | | | |
|---|---|---|---|---|---|---|---|---|
| | 6 | 9 | 12 | 15 | 18 | 21 | 24 | 27 |
| Tensile shear bond strength [MPa] | 2.01 ± 0.81 | 1.44 ± 0.38 | 16.2 ± 3.19 | 18.0 ± 1.56 | 5.01 ± 1.29 | 21.5 ± 1.84 | 10.5 ± 2.31 | 8.39 ± 2.73 |

### Reference Examples 2 to 4

Table 6 shows the evaluation results of the adhesive strength for Reference Examples 2 to 4. In Reference Examples 2 to 4, adhesive strength was evaluated by using a commercially available alicyclic bisepoxy compound not-based from a plant represented by the above formula (9) in place of the plant-based multifunctional epoxy compound. In Reference Example 2, 65 mass % of an alicyclic bisepoxy compound and 35 mass % of BPEI having a molecular weight of 600 were mixed, and in Reference Example 3, 65 mass % of an alicyclic bisepoxy compound and BPEI having a molecular weight of 1800 were mixed with 35 mass % were mixed, and in Reference Example 4, a composition in which 65 mass % of alicyclic bisepoxy compound and 35 mass % of BPEI having a molecular weight of 10,000 were mixed. The mixed compositions in Reference Examples 2 to 4 were prepared and subjected to the same procedure as in Example 6.

TABLE 6

| | | Reference Example | | |
|---|---|---|---|---|
| Table 6 | | 2 | 3 | 4 |
| Epoxy compound | Plant-based bifunctional Epoxy compound | | | |
| [mass %] | Plant-based Trifunctional Epoxy compound | | | |
| | Plant-based Tetrafunctional Epoxy compound | | | |
| | Alicyclic bis Epoxy compound | 65 | 65 | 65 |
| Crosslinking | BPEI (600) | 35 | | |
| agent | BPEI (1800) | | 35 | |
| [mass %] | BPEI (10000) | | | 35 |
| | Tetraethylene pentamine | | | |
| | 2-ethyl-4-methylimidazole | | | |

| | | | |
|---|---|---|---|
| Yield [%] | | | |
| 10% thermal weight loss temperature [° C.] | | | |
| Transmittance [% @ 400 nm] | | | |
| Tensile shear bond strength [MPa] | 15.6 ± 2.30 | 14.7 ± 2.86 | 11.7 ± 0.78 |

As shown in Table 5, when a plant-based bifunctional epoxy compound was used, the adhesive strength was 2 MPa or less. In the case of using a plant-based trifunctional epoxy compound, there was an adhesive strength of 16 to 18 MPa for BPEI 600 or BPEI 1800, and in the case of using the plant-based tetrafunctional epoxy compound, it was adhesive strength of about 21 MPa for BPEI 600. According to these results, it was found that better adhesion strength can be obtained when using a more functionalized one, plant-based trifunctional epoxy compound or plant-based tetrafunctional epoxy compound.

As shown in Table 6, in Reference Examples 2 to 4 adhered using a commercially available alicyclic bisepoxy compound, the adhesion was 11 to 15 MPa, whereas in Example 12 using a plant-based multifunctional epoxy compound, the adhesive strength of 15 and 21 exceeded the adhesive strength in Reference Examples 2 to 4. The adhesive strength in Example 12 could withstand sufficient even when high adhesive strength was required in practical use.

In the present invention, since limonene is used, a crosslinked product can be conveniently prepared using an essential oil contained in citrus squeezed cake. Moreover, as described above, flexible elastomers to cured products having comparatively toughness can easily be produced separately. As obvious from its composition, we can reduce dependency on petroleum resources by 35 to 44%. Furthermore, a high adhesive strength (about 21 MPa) can be achieved.

The embodiments of the invention in which an exclusive property or privilege is claimed are defined as follows:

1. A crosslinkable composition comprising:
a plant-based multifunctional epoxy compound; and
a crosslinking agent, wherein
the multifunctional epoxy compound is obtained by multifunctionalizing limonene oxide, and
the crosslinking agent is a polyalkyleneimine.

2. The crosslinkable composition of claim 1, wherein the crosslinking agent is a polyethyleneimine.

3. The crosslinkable composition of claim 1, wherein the crosslinking agent is a polyethyleneimine having a branched structure.

4. The crosslinkable composition of claim 1, wherein the plant-based multifunctional epoxy compound is a compound obtained by reacting the limonene oxide and a multifunctional thiol.

5. The crosslinkable composition of claim 1, wherein the limonene oxide contains limonene oxide in a trans form of 40 mol % or more with respect to all limonene oxide.

6. The crosslinkable composition of claim 1, wherein the plant-based multifunctional epoxy compound is a tetrafunctional epoxy compound.

7. A cured product obtained by curing the crosslinkable composition of claim 1.
